(19) United States
(12) Patent Application Publication
(10) Pub. No.: US 2011/0232770 A1
(43) Pub. Date: Sep. 29, 2011

(54) Irrigation System Leak Controller and Method

(76) Inventor: D. David Baggett, Coppell, TX (US)

(21) Appl. No.: 12/730,573

(22) Filed: Mar. 24, 2010

(51) Int. Cl. E03B 1/00; F16K 31/12

(52) U.S. Cl. 137/12; 137/486

(57) ABSTRACT

A device and method for preventing leak losses in irrigation system zones is disclosed, wherein the device and method monitor a fluid flow characteristic to detect leak conditions, and automatically close off fluid flow to a zone in which a leak condition is detected.

### FIELD OF THE INVENTION

The invention pertains to irrigation systems, particularly devices and methods of controlling leaks in such systems.

### BACKGROUND OF THE INVENTION

Irrigation systems, especially automatic irrigation systems, allow for the distribution of water over areas of land. Permanently installed irrigation systems usually include an piping system that distributes water to sprinkler heads of various designs and functions. To maintain operational water pressure in a sufficiently large irrigation system, the system may be divided into multiple zones that do not operate simultaneously. Smaller systems may comprise single zones. Such systems may be operated by either manual or automatic controls.

Fully automated systems may include a programmable control system that can be set to operate specific zones at set times, and are often intended to operate for extended periods without human intervention. However, there are limitations to this reliability. Among the failures that can occur are leaks that can be caused by, for example, the failure or breakage of a sprinkler head, or more rarely, by a break in the piping. Such leaks, especially those caused when a sprinkler head breaks, can result in an open flow condition. These leaks waste water and can damage landscaping due to a large amount of water flow being concentrated in a small area.

Additionally, when leaks do occur, they can happen in areas that are not readily visible to people who may be in the area, or when no one is around. Thus, leaks can go undetected for an extended period while the irrigation system cycles on and off repeatedly. These conditions allow the continuous waste of water and can result in more extensive damage to landscaping than would occur if the leak were promptly identified and prevented.

Accordingly, it is a goal of the invention to provide an automatic shutoff of an irrigation zone when an excessive flow condition is detected in that zone.

It is a further goal of the invention to close off one zone with a fault in a multi-zone irrigation system without disrupting the functioning of the other zones.

It is another goal of the invention to provide leak prevention for irrigation zones without requiring changes from conventional designs.

It is yet another goal of the invention to provide notification that a leak has occurred in an irrigation zone.

### SUMMARY OF THE INVENTION

The invention comprises a device and method for determining whether a flow characteristic of fluid, for example pressure or flow rate, in an irrigation system zone has deviated from an expected value, and, if such deviation is sufficiently significant to indicate a leak, for shutting off flow to that zone until the leak is repaired.

The device comprises a zone control unit that senses whether a flow characteristic in its zone is out of the normal range for that flow characteristic. Such conditions occur if there is a fault in the zone such as a broken water pipe or flow head. If the flow characteristic is out of range, the zone control unit removes power from the zone control solenoid, thus shutting off water flow to the zone, and preferably “latches” itself into the off state for as long as the master control unit has the zone turned on. Once power to the zone is turned off, the zone control unit preferably resets automatically so that, if the leak has been repaired, the zone will automatically return to its normal function. Conversely, if the leak has not been repaired and the master control unit again turns the zone on, the zone control unit will again sense the leak and turn the zone off.

In a preferred embodiment, the zone control unit comprises a delay timer to allow the zone to reach its steady-state flow before the zone control unit can operate to turn off the zone. This delay allows air to be purged from the zone and pressure to come up to normal levels if the zone is functioning correctly. The delay will depend on the volume of the piping in the zone and the expected supply characteristics.

The zone control unit is preferably integrated with and has the same electrical connections as an industry-standard solenoid valve control, allowing systems to be easily and inexpensively retrofitted, and allowing new systems to incorporate the invention without changes to conventional system designs.

In an additional embodiment, a signal, such as a warning light or buzzer, provides notification that a zone control unit has detected a fault in a zone and turned the zone off. In closely monitored systems, a warning light or buzzer or a combination thereof will be sufficient. However, in remote or only occasionally monitored systems, the system may be linked to a landline or cell phone transmitter to provide a telephone or form of message to provide notification of the existence of a fault.

In accordance with the invention, irrigation systems can be made less susceptible to water wastage and landscaping damage when breaks occur, and the remainder of the system will continue to function normally.

### BRIEF DESCRIPTION OF THE DRAWINGS

FIG. 1 is a schematic view of a multiple-zone irrigation system.

FIG. 2A is a schematic view of one embodiment of the present invention in a normally operating condition.

FIG. 2B is a schematic view of one embodiment of the present invention in a shut-down condition due to a flow fault in the zone.

FIG. 3A is a schematic view of an embodiment of the present invention including a signaling unit.

FIG. 3B is an alternative schematic view of the system embodiment of FIG. 3A.

### DETAILED DESCRIPTION

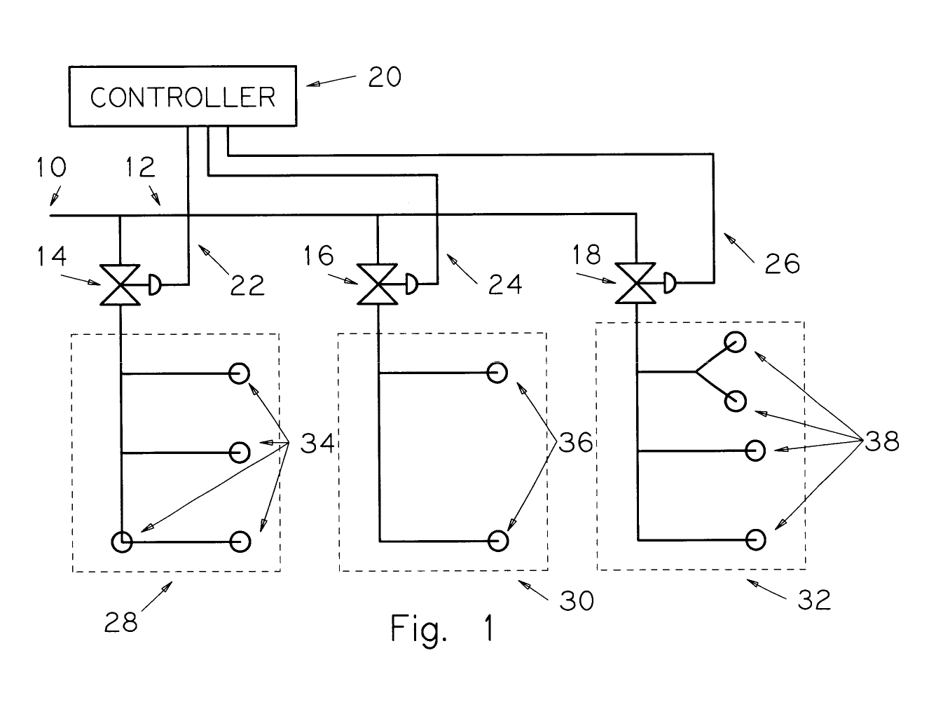

Referring to FIG. 1, a schematic view of a zoned irrigation system includes water inlet 10, which provides a water source through main water line 12 to controllable solenoid valves 14, 16, and 18. Controller 20, typically a programmable controller, is in signal communication with solenoid valves 14, 16, and 18 via control lines 22, 24, and 26, allowing controller 20 to selectively switch solenoid valves 14, 16, and 18 on and off, and thus selectively allowing water flow into irrigation zones 28, 30, and 32, respectively. Control lines 22, 24, and 26 are typically two-wire lines providing an AC control signal (typically 24V) to each solenoid valve. Irrigation zones 28, 30, and 32 have respective flow heads 34, 36, and 38, which may be any type of flow heads known in the art, and which will be patterned as needed to provide the desired pattern of water flow to the respective zone.

Those of skill in the art will recognize that the number of zones and the size, type, and number of flow heads within each zone is a matter of design choice, and that the use of three zones in FIG. 1 is by way of example only. In practice, such an irrigation system might have only a single zone, or as many zones as necessary to properly irrigate the area.

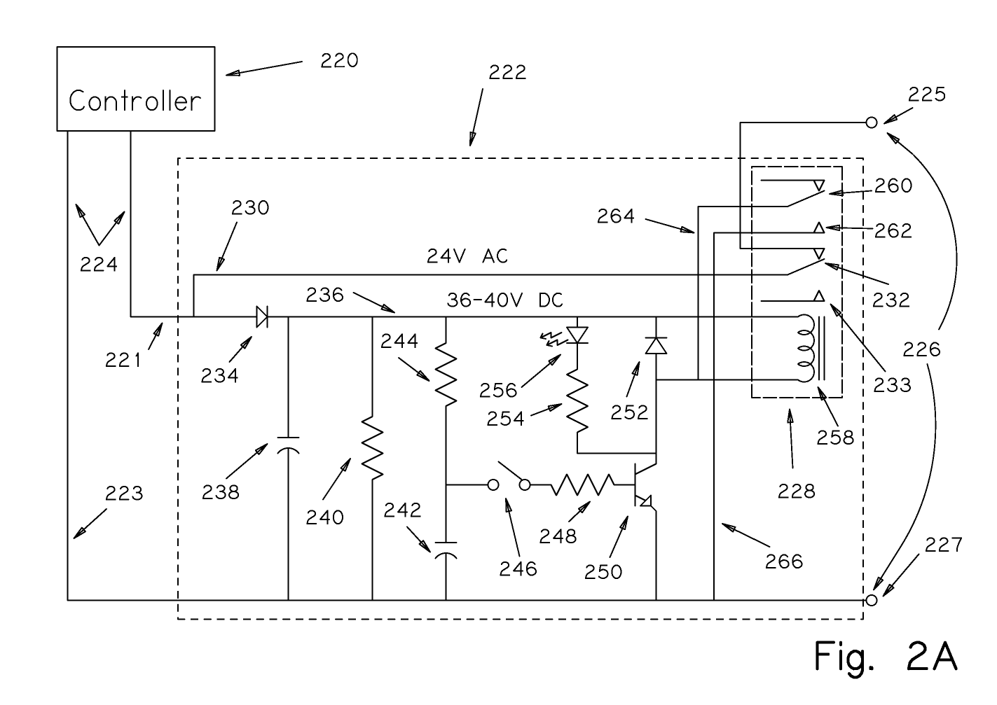

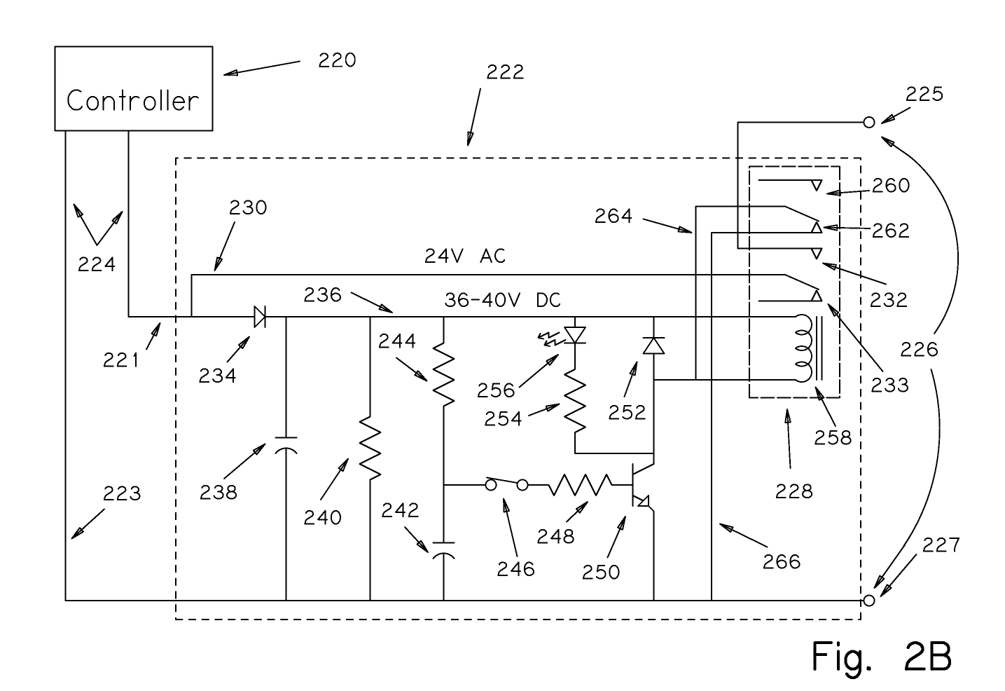

Referring now to FIGS. 2A and 2B, FIG. 2A is a schematic reflecting an embodiment of the present invention as applied to one zone is shown in its normally operating condition. FIG. 2B reflects the same embodiment when a flow fault has been detected, causing the zone to be shut off.

Controller 220 (corresponding to controller 20 of FIG. 1) is in signal communication with zone control unit 222, the components of which are indicated by the outer dashed line. Two-wire control line 224 provides signal communication between controller 220 and zone control unit 222, and typically provides 24V AC when the zone is “on.” After controller 220 turns on the zone controlled by zone control unit 222, the zone control unit 222 will turn the zone off if an abnormal flow condition (such as that caused by a broken pipe or flow head) occurs.

Outputs 226 are in signal communication with the zone control solenoid (not shown), which allows water to flow in the zone when the zone is on, and prevents flow when the zone is off. In normal operation (FIG. 2A), double-pole, double-throw relay 228 (designated by the inner dashed line) is not energized. Bypass line 230 is in signal communication with first input line 221 of two-wire control line 224, and with first output terminal 225 through a first normally-closed contact 232 of relay 228. Second input line 223 is in direct signal communication with second output terminal 227. Thus, when zone control unit 222 is in normal operating mode, the 24V AC signal from controller 220 passes directly to the the zone control solenoid (not shown).

Zone control unit 222 comprises first diode 234, typically a 1N4002 or equivalent diode, which rectifies the 24V AC signal from controller 220 when the zone is on, and provides effective DC power (approximately 36-40V DC at internal power line 236) to the other electronics.

First capacitor 238 and first resistor 240 comprise an “RC” delay circuit that retards the full power-on status of the remainder of the electronics, thus allowing pressure in the water lines time to reach a normal, steady-state condition. This delay prevents zone control unit 222 from prematurely detecting a “low pressure” condition and shutting off flow to the zone. For example, values of 220 μF and 10KΩ for first capacitor 238 and first resistor 240, respectively, would provide and RC time constant of approximately 2.2 seconds, with some variance expected for tolerances of the components.

The initial delay period is a matter of engineering choice, and will be determined in part by the volume of the water lines in the zone. The initial delay period serves to allow pressure to rise in the water lines in the zone and to allow air to be flushed out, thus preventing a spurious low pressure reading.

Second resistor 244 and second capacitor 242 provide filtering for the “downstream” electronics. In one example, values of 8.2 MΩ for second resistor 244 and 220 μF for second capacitor 242 have been found acceptable. Additionally, second resistor 244 in conjunction with third resistor 248 provide biasing resistance for transistor 250. Transistor 250 must have sufficient current capacity to allow it to activate coil 258 of relay 228. Transistor 250 may, for example, be a darlington such as a MPSA13 darlington.

Pressure switch 246 may be placed in the zone water line either upstream or down-stream of the zone control solenoid (not shown), or may be built into the zone control solenoid, itself. In the example of FIGS. 2A and 2B, the pressure switch is open when pressure is normal and closed when pressure falls below a preset limit. However, those of skill in the art will recognize that, with appropriate adjustments to the electronics, a which is open on low pressure could also be used.

Referring now in particular to FIG. 2B, the zone control unit 222 changes state when a fault occurs in the zone during operation, such as a broken water line or loss of a sprinkler head. The resulting low pressure condition closes pressure switch 246, which in turn provides power to, and switches on, transistor 250, activating coil 258 of relay 228. Second diode 252 maintains a DC condition across coil 258, otherwise, internal power line 236 would be in signal communication with the AC signal from second control line 223. Bypass line 230 is switched from first normally closed contact 232 to first normally open contact 233, removing power from first output 225, and thus from the zone control solenoid.

Simultaneously, first internal control line 264, which was originally left open via contact through second normally closed contact 260, is transferred into signal communication with second control line 223 via second normally open contact 262 and second internal control line 266, latching relay 228 into an “on” condition. This latching function prevents the zone from oscillating, or “chattering,” between “on” and “off” states in the event that there are pressure fluctuations in the water lines that cause pressure switch 246 to re-open.

As an option, fourth resistor 254 is in signal communication with transistor 250 (and first internal control line 264), and with internal power line 236 via light emitting diode (“LED”) 256, causing LED 256 to illuminate if the zone has been turned off by the zone control unit 222. As discussed above, LED 256 could be used alone, or be replaced by or used in conjunction with an audible alert, such as a piezoelectric buzzer. Alternatively, more sophisticated alert systems could be provided that perform more involved functions, such as dialing a mobile phone number and sending a text message. However, such alternatives are matters of engineering choice (and expense), and can be used without departing from the spirit of the invention.

If the condition causing the abnormal flow remains unrepaired and controller 220 cycles power to the zone off, the zone control unit will revert to the state of FIG. 2A. Thus, if the controller 220 later (for example, in response to programming for period irrigation) turns the zone back on, water will flow in the zone only until the zone control unit 222 again recognizes the problem condition, at which point the low pressure situation will again cause the zone to be latched “off.”

As those of skill in the art will recognize, such a system is also operable by detecting any flow characteristic of the water in the zone water lines. For example, rather than detecting pressure, the system may detect flow rate. Accordingly, the examples provided above are not limiting of the invention.

Similarly, the control circuitry described above is not considered to be exclusive of other embodiments. Those of skill in the art will recognize that the function provided by the above-described circuitry may be accomplished in a variety of ways without departing from the spirit of the invention. The above-described circuitry is advantageous because it can be incorporated into, or packaged with, industry standard control solenoids, thus allowing existing systems to be retro-fitted with the present invention by a simple replacement of the control solenoid and, if necessary, its associated valve. Similarly, such packaging allows newly installed systems to be installed in the conventional manner, that is, by connecting the two leads of the control wire to the zone control unit, without the need for attaching extra circuitry or wiring.

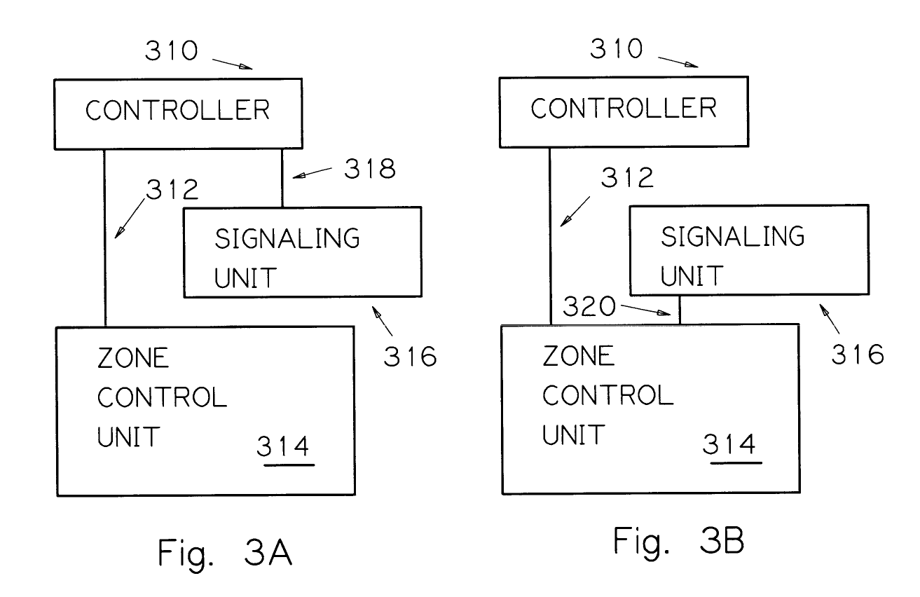

Referring now to FIG. 3A, an alternative embodiment of the zone control system includes a controller 310 in signal communication via first control line 312 with a zone control unit 314 of the present invention, and additionally in signal communication via second control line 318 with signaling unit 316. Signaling unit 316 may comprise any desired device for providing a signal indicating a system fault, including, for example and without limitation of the present invention, a visual alarm such as a light, an audible alarm such as a buzzer or bell, or more sophisticated devices such as modems capable of linking to landline or cell-phone service and providing fault information to a remote location, or any combination of signals. Thus, signaling unit 316 can provide an indication to the irrigation system owner or operator that a zone has shut itself off as a result of an out-of-bounds flow condition.

The configuration of FIG. 3A has the advantage of requiring only a single signaling unit for a multi-zone controller, but would require a controller capable of recognizing when a zone control unit has shut off a zone. An alternative embodiment, reflected in FIG. 3B, provides a signaling unit 316 in signal communication with zone control unit 314 via second control line 320, similar in function to what is reflected internal to the zone control unit 222 in FIGS. 2A and 2B. This embodiment has the advantage of allowing each zone control unit to be pre-configured to allow the attachment of a signaling unit 316 at any time, for example by providing connections to normally-open contact 238 and first lead 225 of two-wire control line 224 of FIGS. 2A, 2B, and 2C. These connections may be provided, for example, via a plug or screw terminals (not shown) provided on the body of zone control unit 314.

A variety of engineering options, both in circuitry and physical configuration, are available to provide the necessary control for the zone control unit and signaling unit. Accordingly, it will be understood that the above descriptions are provided by way of example only, and are not intended as limiting of the invention.

I claim:

1. A method of preventing fluid loss in an irrigation system comprising one or more zones, comprising the steps of
detecting a fluid flow characteristic in a zone when said zone is active, and
automatically closing off fluid flow to said zone if said measured flow characteristic value indicates a leak condition in said zone.

2. The method of claim 1, wherein said detected fluid flow characteristic is a fluid flow rate.

3. The method of claim 1, wherein said detected fluid flow characteristic is a fluid pressure.

4. The method of claim 2, additionally comprising the step of providing a notification when a zone is closed off.

5. The method of claim 3, additionally comprising the step of providing a notification when a zone is closed off.

6. The method of claim 4, wherein said notification comprises an audible sound.

7. The method of claim 5, wherein said notification comprises an audible sound.

8. The method of claim 4, wherein said notification comprises an optically detectable notification.

9. The method of claim 5, wherein said notification comprises a radio frequency signal.

10. The method of claim 4, wherein said notification comprises a radio frequency signal.

11. The method of claim 5, wherein said notification comprises an optically detectable notification.

12. A device for preventing fluid loss in an irrigation system comprising one or more fluid flow zones, comprising
a detector that detects a fluid flow characteristic in said zone when said zone is active, wherein said detector provides an output, and
an automatic shutoff responsive to said output that closes off fluid flow to said zone if said detected fluid flow characteristic indicates a leak condition in said zone.

13. The device of claim 12, wherein said detected fluid flow characteristic is a fluid flow rate.

14. The device of claim 12, wherein said detected fluid flow characteristic is a fluid pressure.

15. The device of claim 12, additionally comprising a signaling device responsive to the state of said automatic shutoff, wherein said signaling device generates a signal receivable externally to said device when said automatic shutoff has closed off fluid flow to said zone.

16. The device of claim 15, wherein said signal generated by said signaling device comprises an optical signal, an audible signal, a telephone signal, or a radio frequency signal.
